(19) United States
(12) Patent Application Publication
(10) Pub. No.: US 2006/0274782 A1
(43) Pub. Date: Dec. 7, 2006

(54) SDH transmission apparatus that can relieve ethernet signal failure

(75) Inventor: Nobuhiro Rikitake, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/502,448

(22) Filed: Aug. 11, 2006

Related U.S. Application Data
(63) Continuation of application No. PCT/JP04/01682, filed on Feb. 17, 2004.

(51) Int. Cl. H04J 3/22

(52) U.S. Cl. 370/465; 370/395.5

(57) ABSTRACT

An apparatus can relieve Ethernet signal failure at connections of Ethernet with SDH/SONET network. In the apparatus, each of current and spare system paths including alarm detecting unit that receives Ethernet signal through a router to detect failure of Ethernet signal; a converting unit that converts Ethernet signal to an SDH/SONET signal, the converting unit converting the SDH/SONET signal to the Ethernet signal; a path switch controlling unit that outputs an insert instruction of an alarm signal for the SDH signal converted by the converting unit when the alarm detecting unit detects failure; an alarm inserting unit that inserts the alarm signal into the SDH/SONET signal based on the insert instruction of the alarm signal from the path switch controlling unit; and a path switch unit that detects the alarm signal inserted into the SDH signal from the alarm inserting unit to switch the path to the spare system.

### CROSS REFERENCE TO RELATED APPLICATIONS

This application is a continuation of International Application No. PCT/JP2004/001682, filed on Feb. 17, 2004, now pending, herein incorporated by reference.

### BACKGROUND OF THE INVENTION

The present invention relates to compound network of the Ethernet and SDH (synchronous digital hierarchy)/SONET (synchronous optical network) network. Particularly, the present invention relates to an SDH transmission apparatus that can relieve a failure of an Ethernet signal at a connecting location between the Ethernet and the SDH/SONET network.

Recently, it is believed that IP network is a mainstream of network, and thus, Ethernet which is IP network is established at one office, while the Ethernet of another office is also established in a remote place.

In such a case, the communication connecting the offices is performed by the SDH/SONET network, which has high quality of line or channel, as a general network configuration.

FIG. 1 is an example of a compound network configuration that connects such Ethernets I, II with SDH network III.

In FIG. 1, the Ethernets I, II are connected with the SDH network III through routers R1, R2. It is assumed that an Ethernet signal failure X occurs between the router R1 of the Ethernet I and the SDH apparatus 101 of the SDH network III.

In such a case, a rout A before the occurrence of the failure is a path passing through the router R1, SDH apparatuses 101, 104, 103, and the router R2. When the failure X occurs, communication cannot be performed through the rout A.

Therefore, a conventional system uses a roundabout route that is different from the route A. For example, in FIG. 1, the communication is generally ensured by using a roundabout route B, which is a path passing through another router R3 of the Ethernet I, i.e., a path passing through the router R3, SDH apparatuses 102, 103, and the router R2.

However, in a method of detecting and relieving the Ethernet signal failure by setting another route with a routing function of a router, a problem is that the time to relief becomes long.

A published technology is known as a technology that prepares a spare line in advance to apply the same signal as the current line (e.g., see patent document 1: Japanese Patent Application Laid-Open Publication No. 2003-134074).

That is, the technology described in the patent document 1 applies a line protecting function of the SDH network to the Ethernet line. This is based on the premise of the application of the same signal (the same transmission rate) to both the current line and the spare line.

Therefore, the technology described in the patent document 1 must add a function for switching between the current line and the spare line to both the router and the SDH apparatus.

Another technology is known as a technology that transfers information of the Ethernet signal failure (patent document 2: Japanese Patent Application Laid-Open Publication No. 2003-110585). However, the patent document 2 does not include specific description of how the alarm transfer function is achieved.

A general method may be a method of adding the Ethernet signal failure information to path overhead. The technology described in the patent document 2 is intended to control link-down with reference to these alarms or SDH alarm information.

However, in the technology described in the patent document 2, the Ethernet signal failure information is not a path switch changeover target alarm. Therefore, the technology cannot be applied to the compound network of the Ethernet and the SDH (synchronous digital hierarchy)/SONET (synchronous optical network) network covered by the present invention.

### SUMMARY OF THE INVENTION

In consideration of the foregoing, the object of the present invention is to provide an SDH transmission apparatus that can relieve a network failure to reduce a relief time of an Ethernet path failure and to achieve efficient transmission capacity without changing an existing network function in the compound network of the Ethernet and the SDH (synchronous digital hierarchy)/SONET (synchronous optical network) network.

To achieve the above object, according to a first aspect of the present invention there is provided an SDH apparatus in compound network connecting Ethernets with SDH/SONET network, the SDH apparatus constituting the SDH/SONET network, comprising a current system path and a spare system path; and a path switch unit that switches the current system path and the spare system path, each of the current system path and the spare system path including an alarm detecting unit that receives an Ethernet signal through a router to detect a failure of the Ethernet signal; a converting unit that converts the Ethernet signal to an SDH signal, the converting unit converting the SDH signal to the Ethernet signal; a path switch controlling unit that outputs an insert instruction of an alarm signal for the SDH signal converted by the converting unit when the alarm detecting unit detects a failure; an alarm inserting unit that inserts the alarm signal into the SDH signal based on the insert instruction of the alarm signal from the path switch controlling unit; and a path switch unit that detects the alarm signal inserted into the SDH signal from the alarm inserting unit to switch the path to the spare system.

In the SDH apparatus according to a second aspect of the present invention, the alarm signal may be inserted by setting all bits of AU-4PTR bytes to “0” in a header portion of a format of the SDH signal.

In the SDH apparatus according to a third aspect of the present invention, the Ethernet signal failure detected by the alarm detecting unit may be input disconnection of the Ethernet signal that is an optical signal, input disconnection of a carrier signal of the Ethernet signal, or unestablished state of the link of the Ethernet.

In the SDH apparatus according to a fourth aspect of the present invention, when it is determined that the performance of the input Ethernet signal is in a predetermined state, the path switch controlling unit may instruct of the insert of the alarm signal.

In the SDH apparatus according to a fifth aspect of the present invention, when the number of error packets of the Ethernet signal exceeds a predetermined value, the path switch controlling unit may determine that the performance of the input Ethernet signal is in the predetermined state.

In the SDH apparatus according to a sixth aspect of the present invention, each of the current system path and the spare system path may be connected to a different port of the router and wherein when the path switch controlling unit switches the path, the transmission to the router may be terminated for the Ethernet signal converted from the SDH signal in the unselected system path.

The features of the present invention will become more apparent from embodiments of the present invention described below with reference to the drawings.

### BRIEF DESCRIPTION OF DRAWINGS

FIG. 1 shows an example of a compound network configuration that connects Ethernets I, II with SDH network III.

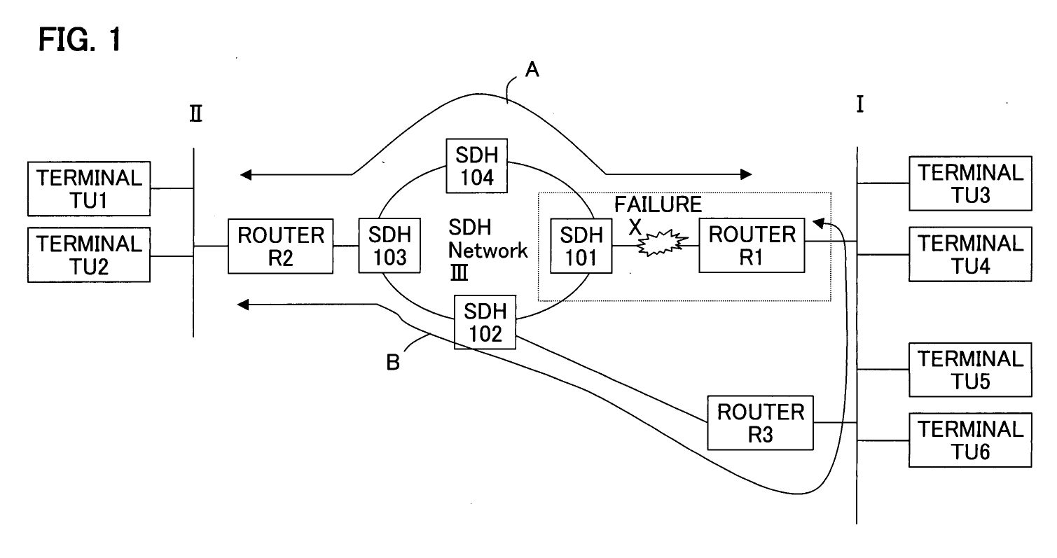

FIG. 2 is a conceptual diagram of a first embodiment of the present invention.

FIG. 3 is a diagram of a VC-4 configuration of a STM1 frame of ITU-T G707.

FIG. 4 is a diagram for describing a specific example of the operation of the embodiment of the present invention.

FIG. 5 is an operational flowchart corresponding to FIG. 4.

FIG. 6 is a diagram of a configuration example of an SDH apparatus showing a second embodiment of the present invention.

FIG. 7 is a diagram of another embodiment.

### PREFERRED EBBODYMENTS of THE INVENTION

Embodiments of the present invention will hereinafter be described with reference to the drawings. The embodiments shown in the figures are for the purpose of describing the present invention and are not intended to limit the technical scope of the present invention.

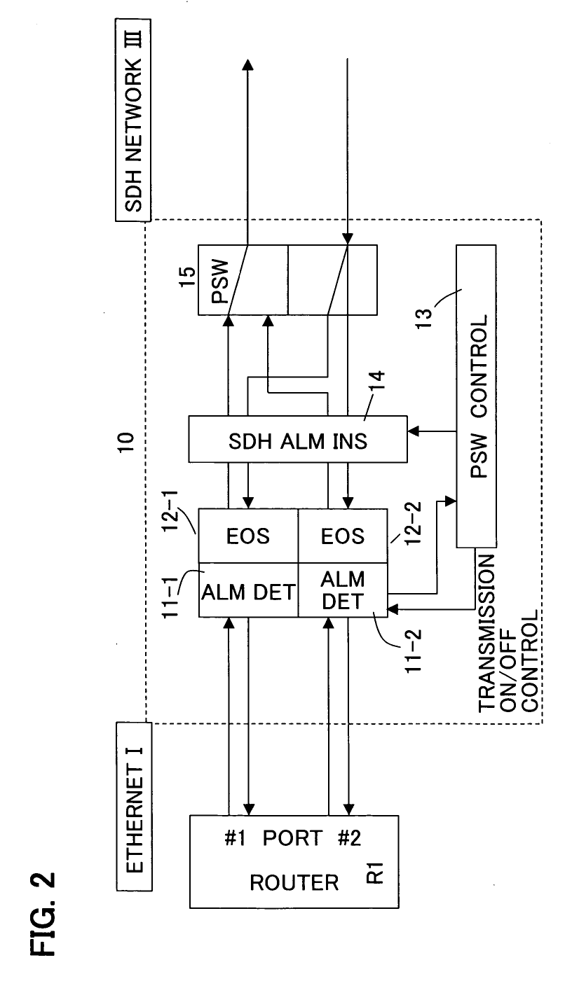

FIG. 2 is a conceptual diagram of a first embodiment of the present invention and shows only a functional unit that achieve an Ethernet path switch protecting function of an SDH apparatus according to the present invention.

The functional unit 10 corresponds to the Ethernet path switch protecting function of the SDH apparatus and each of a pair of alarm detecting (ALM DET) units 11-1, 11-2 is connected to a port #1, #2 of a router R1 of Ethernet I.

The alarm detecting (ALM DET) units 11-1, 11-2 are connected to an AIS signal inserting unit 14 through Ethernet signal extracting (EOS: Ethernet Over SDH) units 12-1, 12-2.

The alarm detecting (ALM DET) unit 11-1 receives a signal from the port #1 of the router R1 and has a function for detecting a failure of an Ethernet signal sent from the router R1. The failure of the Ethernet signal includes the following states.

LOS (Loss Of Signal): input disconnection of optical signal

LOC (Loss Of Carrier): input disconnection of carrier signal of Ethernet

LINKFAIL (Link Failure): unestablished state of link of Ethernet (including failure of auto-negotiation)

The Ethernet signal extracting (EOS: Ethernet Over SDH) units 12-1, 12-2 has a function for receiving the Ethernet signal in the SDH path and, contrary, extracting the Ethernet signal from the SDH path.

When the alarm detecting unit 11-1 detects the Ethernet signal failure, a path switch controlling unit (PSW CONTROL) 13 is notified of the fact that the failure is detected.

When notified of the alarm detection of the Ethernet, the path switch controlling unit 13 communicates the failure detection to a CPU not shown within the path switch controlling unit 13. In accordance with predetermined software, the CPU determines where AIS (alarm identification signal) should be inserted from the position of the occurrence of the failure.

This determination is communicated to the SDH alarm inserting (ALM INS) unit 14 and the AIS is inserted bi-directionally to the relevant path.

The AIS is inserted by setting bytes of AU-4PTR of VC-4 of a STM1 frame to all “0”, for example.

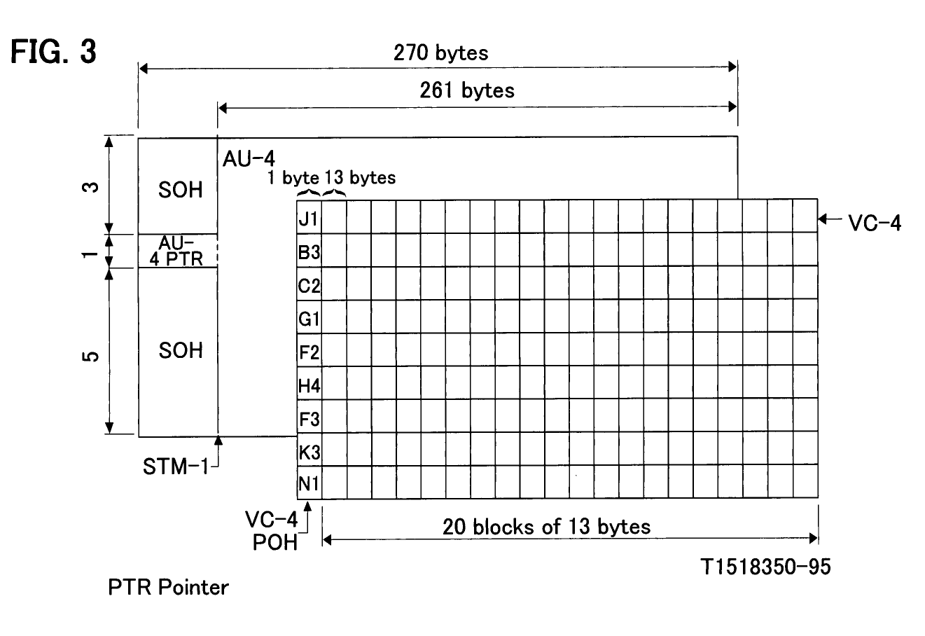

FIG. 3 is a diagram of a VC-4 configuration of a STM1 frame of ITU-T G707. As shown in FIG. 3, a signal with 139,264 bits/sec is mapped in the VC-4 configuration. The payload includes 9 lines of 1-byte path overhead and blocks of 9 lines×260 columns of bytes.

The VC-4 configuration also has overhead of 9 bytes×9 lines and the AIS (AU-AIS signal) is defined by setting predetermined byte AU_4PTR to all “1”.

The AU-AIS signal has a function for notifying the next apparatus that the failure occurs in the signal source (the Ethernet line in this case).

Therefore, the AU-AIS signal inserted by the SDH alarm inserting (ALM INS) unit 14 notifies a path switch (PSW) 15 of the failure and instructs to switch the path.

The path switch (PSW) 15 receives the AU-AIS signal and is switched to the path without the alarm. In this way, a current path is switched to a spare path, which is the port #2 of the router R1 and the alarm detecting unit 11-2. Therefore, the failure is relieved between the router R1 and the SDH apparatus 101 and the communication is continued.

In this way, the present invention relieves the Ethernet signal failure in the SDH/SONET mode providing network with high line quality and can improve the line quality of the Ethernet to achieve a more efficient network configuration.

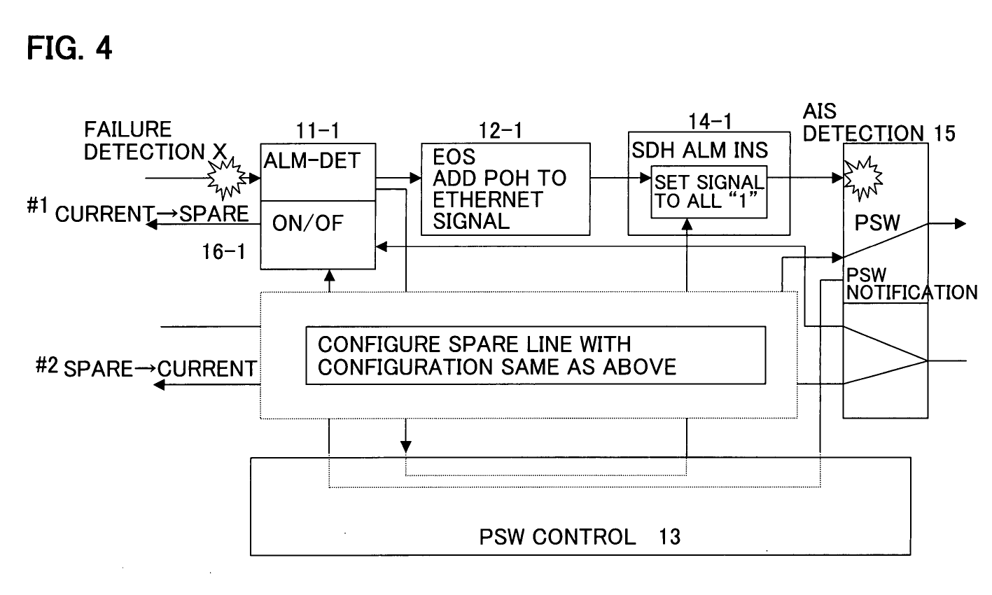

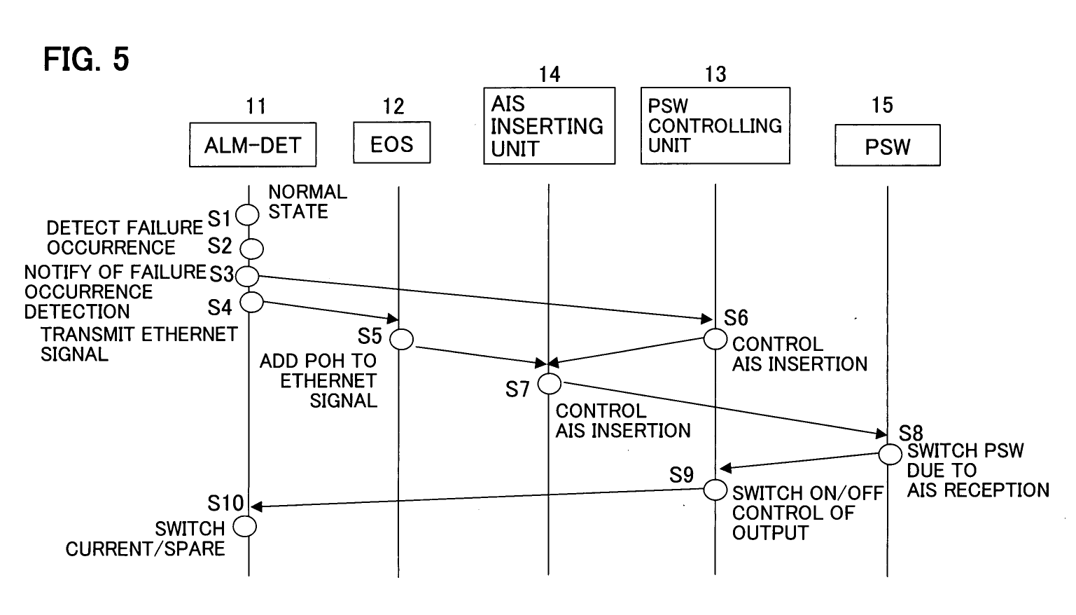

FIG. 4 is a diagram for describing a specific example of the operation of the embodiment of the present invention and FIG. 5 is an operational flowchart corresponding to FIG. 4. In FIG. 4, the current system is each functional unit shown on the side connected to the port #1 of the router R1, and a spare system is included as the same functional units not shown on the side connected to the corresponding port #2 of the router R1.

In FIG. 4, when the path of the port #1 of the router R1 and the SDH apparatus 101 is the current line in a normal state (step S1, FIG. 5), if an Ethernet signal failure X occurs, the alarm detecting unit 11-1 detects the failure (step S2).

The path switch controlling unit 13 is notified of the fact that the failure is detected (step S3). On the other hand, the Ethernet signal is sent to the Ethernet signal extracting (EOS) unit 12-1 (step S4).

As shown in FIG. 3, the EOS unit 12-1 adds the POS of 1 byte×9 lines to the Ethernet signal to generate the payload of the SDH frame, which is sent to the SDH alarm (AIS) inserting unit 14-1 (step S5).

When notified of the failure detection by the alarm detecting unit 11-1 as described above, the path switch controlling unit 13 controls the AIS inserting unit 14-1 to insert the AIS (step S6).

Therefore, the AIS inserting unit 14-1 sets all nine bytes of the AU-4PTR portion to “1” in the SDH signal sent from the EOS unit 12-1 and sends the signal to the path switch (PSW) unit 15 (step S7).

The PSW unit 15 detects that all nine bytes of the AU-4PTR portion of the SDH signal is set to “0”, switches the path to the other side, and notifies the PSW controlling unit 13 of the switching (step S8).

When notified of the execution of the path switching, the PSW controlling unit 13 stops transmission of packets to the Ethernet side correspondingly to the direction of the path switch. In this way, the burden of the router R1 is reduced. That is, the ON/OFF control of signal transmission/reception switching units 16-1, 16-2 of the alarm detecting unit 11 is performed correspondingly to the direction of the PSW unit 15 (step S10).

As described above, the current system and the spare system can be switched to continue the communication.

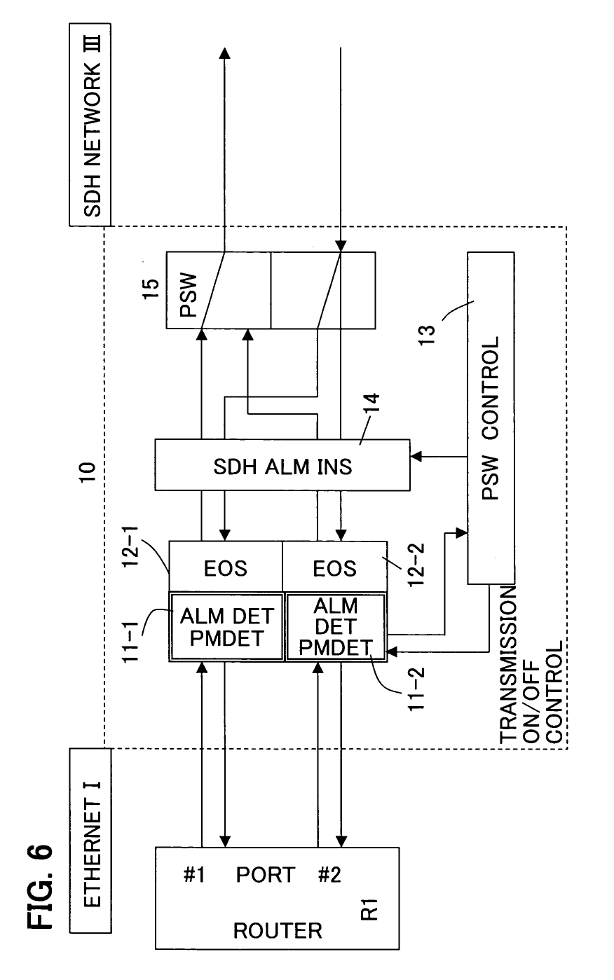

FIG. 6 shows a configuration example of an SDH apparatus showing a second embodiment of the present invention. As compared to the embodiment configuration of FIG. 2, the SDH apparatus is characterized in that the alarm detecting unit 11-1, 11-2 also has a function for monitoring performance.

Although the Ethernet signal failure detection is the same as the operation described in FIG. 4, the alarm detecting unit 11-1, 11-2 also has a monitoring function for performance.

The following functions are supported basically in details of the performance monitoring.

INFRAME count: monitoring of the number of the input packets

OUTFRAME: monitoring of the number of the output packets

OUT ERR FRAME: the number of output error packets

Performance items are varied depending on other services.

The alarm detecting unit 11-1, 11-2 monitors the performance (e.g., number of errors) of the Ethernet signal. The monitored number of errors is sent as performance data to the path switch controlling unit 13.

The path switch controlling unit 13 compares the collected performance states (e.g., the number of errors) of two Ethernet work lines (lines connected to the ports #1, #2 of the router R1) and selects the line in good condition.

The path switch controlling unit 13 determines the path in bad condition, which is communicated to the alarm inserting unit 14 to insert the AIS. When the AIS is inserted, the PSW unit 15 switches the line to the path without the alarm.

The method of inserting the AIS is the same as the description of FIG. 2.

The switch-over due to the performance will be described with specific examples.

1) If error packets are generated to be 30% or more of all received packets, the AIS inserting unit 14 inserts the AIS to the current signal and the PSW unit 15 switches the path to the spare system (only when the spare system is normal).

The error rate for executing the switch-over can be determined arbitrarily.

2) The numbers of the error packets are compared between the current and spare lines for every 24 hours. The switch-over is performed to the line with fewer errors.

(Although the switch-over is immediately performed in the switch-over due to the failure detection, a user can independently set the switch-over due to the performance depending on the concept of network design/quality)

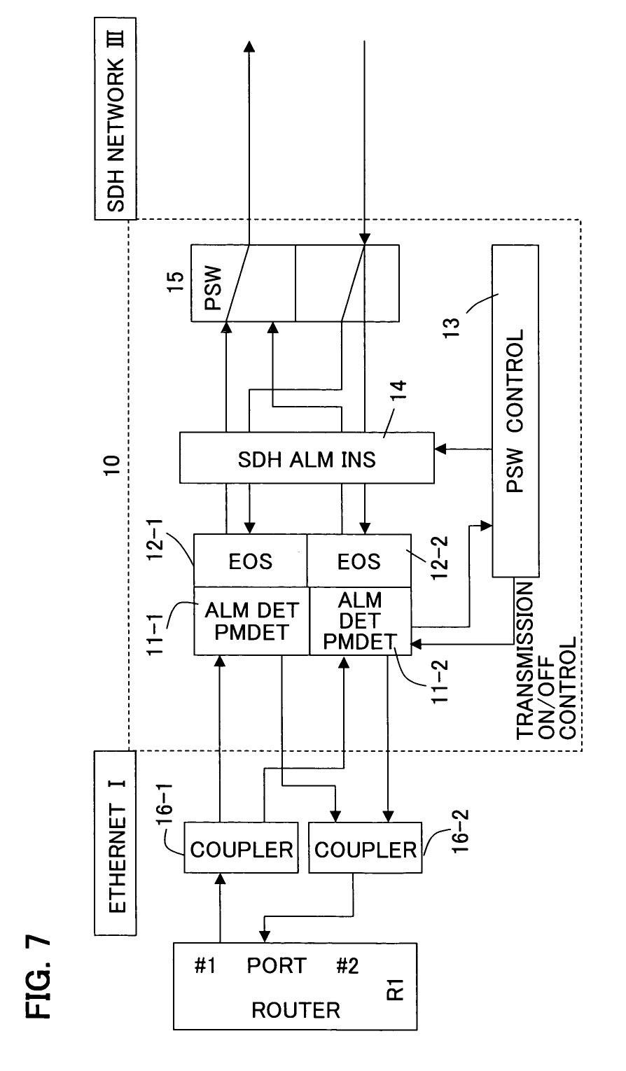

FIG. 7 is a diagram of another embodiment. The embodiment of FIG. 7 is characterized in that couplers 16-1, 16-2 are included as compared to the embodiment described in FIG. 2. That is, the signals are divided/combined between the router R1 and the SDH apparatus 101.

Such a configuration can reduce the frequency of usage of the ports of the router R1.

In FIG. 7, the alarm detecting units 11-1, 11-2 of the SDH apparatus 101 perform the alarm monitoring/performance monitoring for each of two signals divided by the coupler 16-1. If a failure or quality deterioration occurs, the PSW unit 15 switches the path correspondingly to the signal without the failure or signal with better quality as is the case with the above embodiments.

Particularly, such an embodiment fulfills the purpose of relieving the deterioration and failure of the transmission path (optical fiber, etc.)

As is the case with the above embodiments, by discontinuing the line output transmitted from the SDH apparatus to the router to give the appearance of loss (LOS) of the input to the couplers 16-1, 16-2, the switching protection can be performed for the line not selected by the PSW unit 15.

### INDUSTRIAL APPLICABILITY

As described in the above embodiments, since the present invention can achieve a redundant configuration by using an available line as a spare system without changing the current configuration, costs of additional facility investment can be constrained. Therefore, the present invention considerably contributes to the industry.

The following effects can be achieved by the present invention.

(1) The time from the occurrence of the Ethernet signal failure to the relief can be reduced from the relief in second units to millisecond units.

(2) Since the existing SDH function is used, the Ethernet protection can be inexpensively performed only by changing software.

(3) The maintenance can be achieved by the PM monitoring, and the line quality and reliability can be improved in the steady state.

(4) Since signals of two Ethernets are consolidated by PSW, the path capacity of the SDH apparatus can be reduced to a half. In this way, the network usage efficiency is improved.

(5) The current/spare signals may not be configured with the same transmission rate between the SDH apparatus and the Ethernet. For example, the current system may be 1-G Ethernet and the spare system may be Fast Ethernet.

1. An apparatus in compound network connecting Ethernets with SDH/SONET network, the apparatus constituting the SDH/SONET network, and comprising:
a current system path and a spare system path; and
a path switch unit that switches the current system path and the spare system path,
each of the current system path and the spare system path including:
an alarm detecting unit that receives an Ethernet signal through a router to detect a failure of the Ethernet signal;
a converting unit that converts the Ethernet signal to an SDH/SONET signal, the converting unit converting the SDH/SONET signal to the Ethernet signal;
a path switch controlling unit that outputs an insert instruction of an alarm signal for the SDH/SONET signal converted by the converting unit when the alarm detecting unit detects a failure;
an alarm inserting unit that inserts the alarm signal into the SDH/SONET signal based on the insert instruction of the alarm signal from the path switch controlling unit; and
a path switch unit that detects the alarm signal inserted into the SDH signal from the alarm inserting unit to switch the path to the spare system.

2. The apparatus according to claim 1,
wherein the alarm signal is inserted by setting all bits of AU-4PTR bytes to “0” in a header portion of a format of the SDH/SONET signal.

3. The apparatus according to claim 1,
wherein the Ethernet signal failure detected by the alarm detecting unit is input disconnection of the Ethernet signal that is an optical signal, input disconnection of a carrier signal of the Ethernet signal, or unestablished state of the link of the Ethernet.

4. The apparatus according to claim 1,
wherein when it is determined that the performance of the input Ethernet signal is in a predetermined state, the path switch controlling unit instructs the insert of the alarm signal.

5. The apparatus according to claim 4,
wherein when the number of error packets of the Ethernet signal exceeds a predetermined value, the path switch controlling unit determines that the performance of the input Ethernet signal is in the predetermined state.

6. The apparatus according to claim 1,
wherein each of the current system path and the spare system path is connected to a different port of the router and wherein when the path switch controlling unit switches the path, the transmission to the router is terminated for the Ethernet signal converted from the SDH/SONET signal in the unselected system path.

7. A compound network connecting Ethernets with SDH/SONET network,
the compound network connecting the Ethernet and the SDH/SONET network through an apparatus that constitutes the SDH/SONET network and a router that is connected to the Ethernet,
the apparatus constituting the SDH/SONET network comprising:
a current system path and a spare system path; and
a path switch unit that switches the current system path and the spare system path,
each of the current system path and the spare system path including:
an alarm detecting unit that receives an Ethernet signal through a router to detect a failure of the Ethernet signal;
a converting unit that converts the Ethernet signal to an SDH/SONET signal, the converting unit converting the SDH/SONET signal to the Ethernet signal;
a path switch controlling unit that outputs an insert instruction of an alarm signal for the SDH signal converted by the converting unit when the alarm detecting unit detects a failure;
an alarm inserting unit that inserts the alarm signal into the SDH/SONET signal based on the insert instruction of the alarm signal from the path switch controlling unit; and
a path switch unit that detects the alarm signal inserted into the SDH/SONET signal from the alarm inserting unit to switch the path to the spare system.
